(19) United States
(12) Patent Application Publication
(10) Pub. No.: US 2008/0294670 A1
(43) Pub. Date: Nov. 27, 2008

(54) METHOD AND SYSTEM FOR HIERARCHICAL LOGGING

(76) Inventors: Lazar Borissov, Sofia (BG); Vera Naydenova, Wiesloch (DE); Dimitar Grancharov, Sofia (BG); Nina Petrova, Sofia (BG)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/751,401

(22) Filed: May 21, 2007

(51) Int. Cl. G06F 17/30; G06F 3/00

(52) U.S. Cl. 707/102; 707/200; 719/318; 707/E17.005; 707/E17.055

(57) ABSTRACT

A method and system to create a logical hierarchy of log files is described. The method records data about each event occurring during a maintenance procedure in a first order log file. Detailed information about the event is redirected to a further order log file. In some case, the hierarchical nature allows the event data to be analyzed and the error causing the event to be corrected without human intervention.

### BACKGROUND

1. Field

The field of invention relates generally to software environments, and more specifically to maintaining and managing log files.

2. Background

Application servers are platforms that host and provide services to applications. Application servers manage the life cycles of applications and take care that the logic implemented in applications is accessible to clients in a centralized fashion. With the initial installation of an application server, a number of configuration tasks are performed so that the application server is customized to the underlying system environment and so that the application server is configured according to the functional requirements for its use.

After the initial installation and configuration of an application server, there may be a number of new features supplied by the vendor that need to be applied. In such situations, updates for software components are downloaded at a predefined location and applied on the environment. This is referred to as a “maintenance procedure”. A system executes the maintenance procedure and records data about all operations performed as part of the procedure in a file.

Similarly to maintenance procedures, many operations performed by software applications record information in predefined files. Usually, such records are kept in a dedicated file. Keeping records about an operation in a file is referred to as “logging”. However, there are many complex operations that can produce a lot of output and thus the file that keeps the records becomes very large very quickly.

If a technical problem occurs during a maintenance procedure, it is the responsibility of technical support units to read and analyze the file with data for the performed tasks to identify reasons for technical supports issues. There are many difficulties associated with this process, starting with the size of the file, and also the fact that data about events is recorded in the order it is received. This means that the reasons for an event, the event itself, and the consequences following from that event can be recorded at any place in the single file with no indication that they are related. In effect, a simple technical problem can take hours and even days to identify.

### SUMMARY OF THE INVENTION

A method and system to maintain data about maintenance operations on software components is described. Data about each event occurring during a maintenance procedure is recorded to a first order log file and details about the event are redirected to a further order log file. The resulting logical hierarchy of log files is analyzed and in some cases the technical problem that produced the event recorded in the first order log file can be solved without human intervention.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a flowchart that depicts the process of maintaining and redirecting data for events occurring during a maintenance procedure.

FIG. 2 is a bock diagram of the message format of messages logged to a log file.

FIG. 3 is a flowchart that depicts the process of analyzing data in a logical hierarchy of log files.

FIG. 4 is a flowchart that depicts an automated procedure to analyze and act on data maintained in a logical hierarchy of log files.

FIG. 5 is a block diagram of an example of a logical hierarchy that is created from the execution of a maintenance procedure.

FIG. 6 is a block diagram of a system in which embodiments of the invention may be implemented.

### DETAILED DESCRIPTION

Descriptions of certain details and implementations follow, including a description of the figures, which may depict some or all of the embodiments described below, as well as discussing other potential embodiments or implementations of the inventive concepts described herein.

Operations performed by software applications often involve maintaining records for each performed task. Such records are kept so that operations can be analyzed, benchmarked, and optimized. Keeping records for performed tasks is also referred to as “logging”, in the sense that each piece of data is “logged” to a file. This description explains how such log files can be broken down into smaller related files and organized into logical hierarchies. Further, this description explains how such logical hierarchies can be automatically analyzed an acted upon so that supportability tasks are performed without the need for human intervention.

In one embodiment of the invention, maintenance procedures are performed on software components. A maintenance procedure is a set of tasks that updates or upgrades software components. In some embodiments of the invention described below, a maintenance procedure involves checking if newer versions of software components are available at a location over a network and downloading necessary versions of components from the location on the network to a location on a file system accessible to the maintenance procedure. In prior art methods, with the start of the maintenance procedure, the system performing the procedure starts recording data in a dedicated log file for each event that is part of the procedure. In an improvement over the prior art, the system detects complex events and redirects output about such events into further order log files. Thus, the main log file is referred to as “first order log file” and further related log files are referred to as “second order log file”, “third order log file”, and so on. Furthermore, log files from each order are organized into a logical hierarchy.

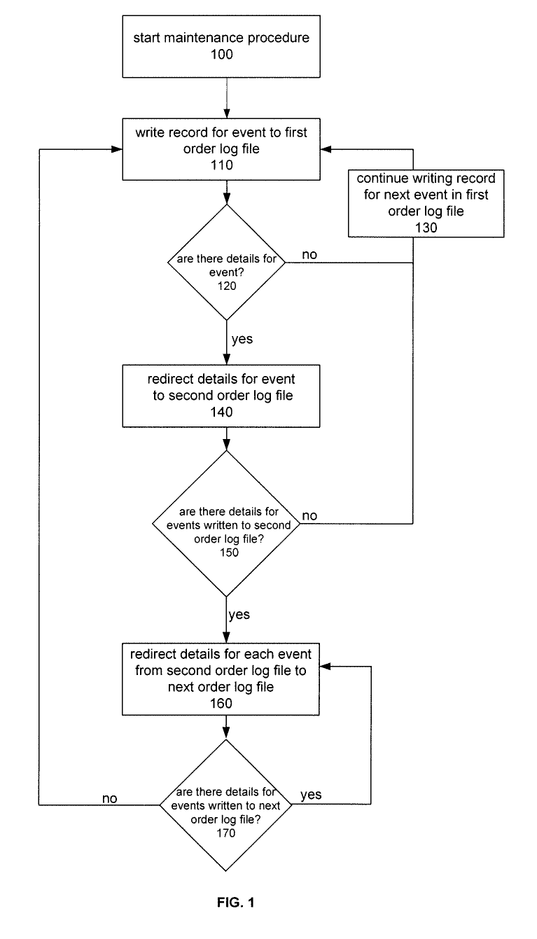

Referring to FIG. 1, the maintenance procedure starts 100, and the system starts maintaining records for events in the first order log file 110. If there are further details for the event 120, the system will proceed to create a dedicated second order file and redirect output for such details to it 140. When all available output is redirected, the system will proceed with the maintenance procedure and log the next event in the first order log file 130. However, it is conceivable that the output redirected to the second order log file contains events that also have details associated with them 150. In such an occurrence, the system creates a dedicated third order log file for each event in the second order log file 160. This process iterates until the system has recorded all details for all events in any number of further order log files as necessary. Finally, when a chain of events is exhausted and all events have details for them written to log files, the system again resumes the maintenance procedure and proceeds with writing details for a further event to the first order log file 110.

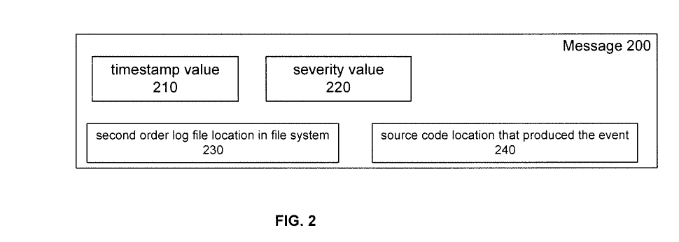

Records written to log files are in the form of so-called “messages”. FIG. 2 is a block diagram of a message 200. Messages have the following format: a timestamp value 210 providing the exact date and time of the event occurred, a severity value 220 that indicates the importance of the message, a location in the file system of a second order log file 230, and a location in the source code 240 that produced the message. Severity values describe predefined categories of message types. For example, a message may indicate that an error has occurred and the maintenance procedure may not continue until the error is resolved. In other instances, messages provide only data for the flow of the maintenance procedure. For example, such messages provide notifications for the creation of further order log files.

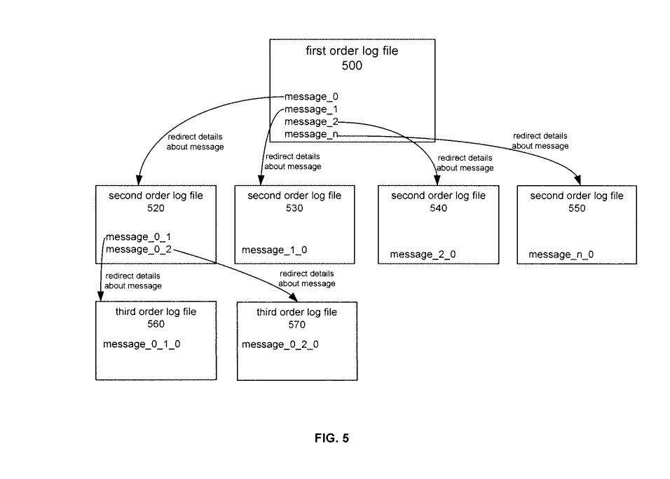

FIG. 5 shows an example of a created logical hierarchy of log files. The system starts the maintenance procedure, creates a first order log file 500, and logs message_0. Message_0 has further details associated with it, thus a second order log file 520 is created to store redirected output, i.e. message_0_1 and message_0_2. The messages in the second order log file also have further details and the system creates further order log files, third order log file 560 and third order log file 570 to write details for each of the messages in the second order log file 520. Once the process completes, i.e. there are no further details for redirection, the system proceeds with the maintenance procedure and logs message_1. Details about message_1 are logged to the second order log file 530. Similarly, details about further messages from the first order log file are logged into second order log files 540 and 550. The logical hierarchy as described above is only an example of the result of an execution of a maintenance procedure. Depending on the complexity and number of events that are recorded, the logical hierarchy can expand in depth and breadth as necessary until all relevant data is recorded. It is important to note, however, that log files from one order of the hierarchy are not interrelated. Each log file from a lower log order is only related directly to its parent in the hierarchy (and possibly one or more child log files). Furthermore, the logical hierarchy can be displayed in a Graphical User Interface (GUI) so that the final load of data is easily maintained and inspected.

As noted above, prior art maintenance procedures keep all output in one log file, thus producing an enormous amount of data from many sometimes unrelated events. Analyzing the single file is a time consuming and complex task as events are logged as in the order they occur, that is, an event that is a consequence of a prior event might not be logged until some other events are recorded. In effect, the reason for an event, the event itself, and the consequences from the event can appear at arbitrary lines of the single log file. Thus, an analysis of the single log file involves reading a considerable amount of the single log file around a specific timeframe so that all events that are related to each other are identified and analyzed. Spreading the event data among related smaller files reduces time and manpower previously required to analyze such prior art large monolithic log files. With the described logical hierarchy, the connection between events is immediately recognized. Thus, identifying and solving a technical problem encountered during a maintenance procedure is significantly easier as the smaller files and hierarchical organization permits problems to be easily identified by following the hierarchy down to the last of related further order log files. This saves time and cuts costs associated with resolving technical support issues. As an additional benefit, displaying the logical hierarchy of log files in a graphical user interface facilitates the identification of chains of related log files in the hierarchy.

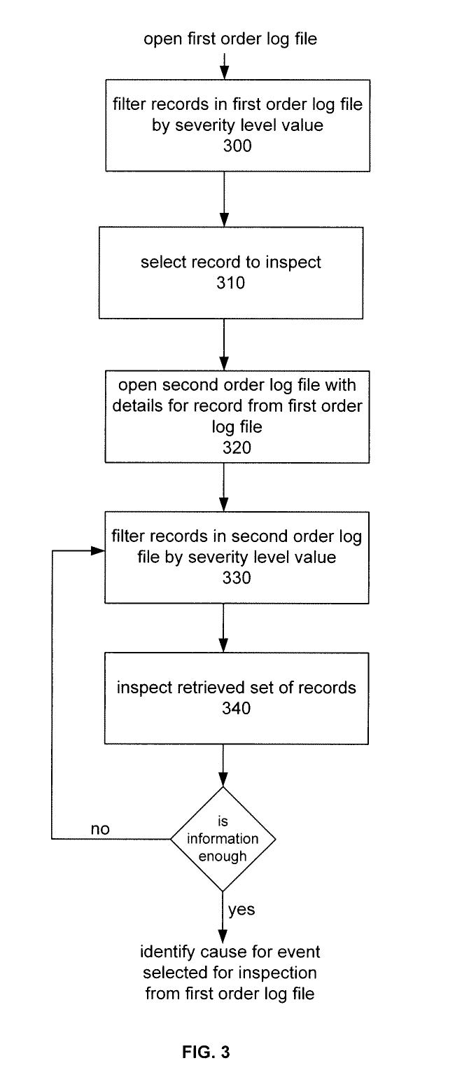

FIG. 3 describes the improved process for event analysis in accordance with one embodiment of the invention. The process starts with opening the first order log file. To facilitate the analysis, messages are filtered according to their severity level value 300, e.g. the analysis starts from the most important messages. The retrieved list is naturally much smaller and the searched event is identified from the list 310. From the data provided in the message logged for the event, a location in the file system for the related second order log file is retrieved and the related second order log file is opened 320. As there may be many messages related to the selected message from the first order log file, the second order log file may also be filtered using a desired severity level value 330. Finally, the retrieved list is inspected 340 and reasons for the logged event are identified. However, the retrieved list of filtered messages may not provide enough data for an explanation of the event that is the subject of the analysis. In such situations, the second order log file will be filtered again with a different severity level value. The process can be repeated until there is enough data to complete the analysis. At each iteration of the process only a smaller subset of the original messages set needs to be read and analyzed, and this significantly reduces the amount of time associated with identifying and resolving technical problems.

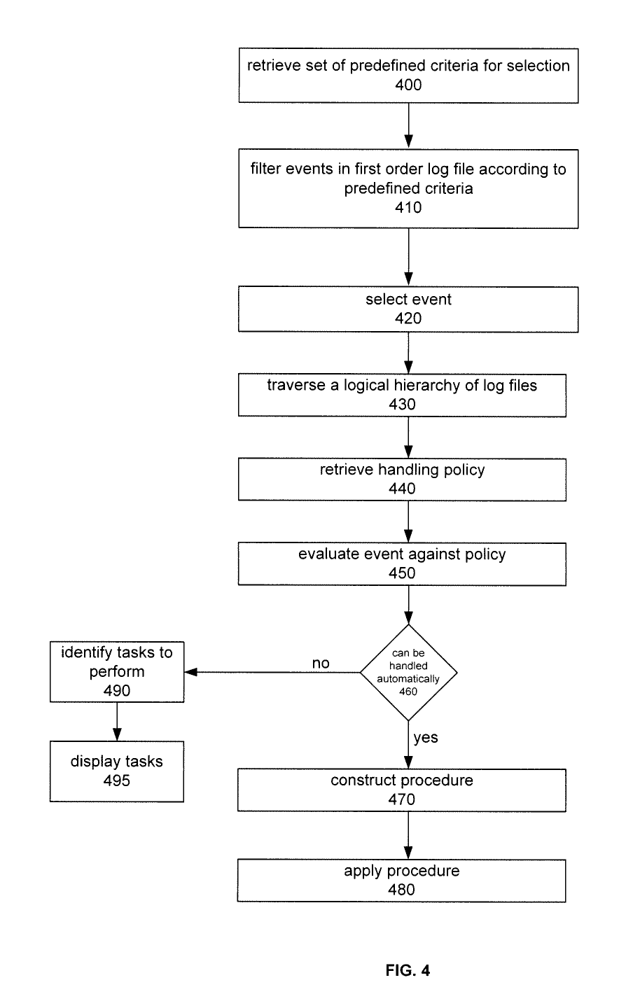

The logical relationship between higher order log files and lower order log files permits the creation of automated procedures to respond to technical problems. This in turn significantly reduces the amount of time needed to solve a technical problem as the need for human intervention in the process may be reduced or eliminated. FIG. 4 describes an embodiment of the invention where a method for automated analysis of technical support issues is implemented. The automated process starts with retrieving a set of predefined criteria for selection 400. The system then filters events according to the criteria 410 and selects an event for analysis 420. Then, the logical hierarchy of log files is traversed 430 and from the information in the message recorded for the event in the first order log file, a chain of lower order log files storing events related to the selected event is retrieved. When all details related to the event detected in the first order log file are retrieved form the hierarchy, the system retrieves a handling policy 440 and analyzes all collected data against the policy 450. If the event can be handled automatically, a procedure for acting on the event based on the performed analysis is constructed 470 and applied to the software components 480. Thus, embodiments of the invention not only significantly reduce the time invested in solving technical issues but also may eliminate the need for the involvement of technical support units altogether. The logical hierarchy is especially important for the automatic handling of events because without its existence the system would not be able to identify reasons for the occurrence of an event and apply a procedure to solve the technical problem. The system is able to identify reasons for events because it is able to retrieve all data pertaining to an event. The data can be collected because there is a logical relationship between higher order log files and lower order log files. Without this relationship, a logic can simply scan a single log file for messages, select an event for handling, but there will be no indication of messages that are related to the selected event. In such a case, because of the lack relevant data, no estimation if the event can be handled automatically can be performed, reasons for the event cannot be identified, and no adequate procedure can be constructed and applied. However, there can be solutions to technical problems that demand a complicated process to be executed. For example, as a result of an error, several different procedures performed in a specified order may be necessary. The procedures to carry out and the order that they must be executed may be specific to the environment state after the maintenance procedure has been performed. In one embodiment, if the system cannot resolve a technical problem automatically, it will collect instructions and relevant reference information 490 and display the collected data 495.

The benefits achieved from the invention are of crucial importance as the software industry estimates that one of the highest costs associated with software systems is the cost of maintenance. Since the embodiments of the invention provide for a reduction of time involved in solving technical issues in terms of several times less than in prior art, this in turn reduces the funds that need to be invested in the process and finally reduces the Total Cost of Ownership (TCO) of a software system.

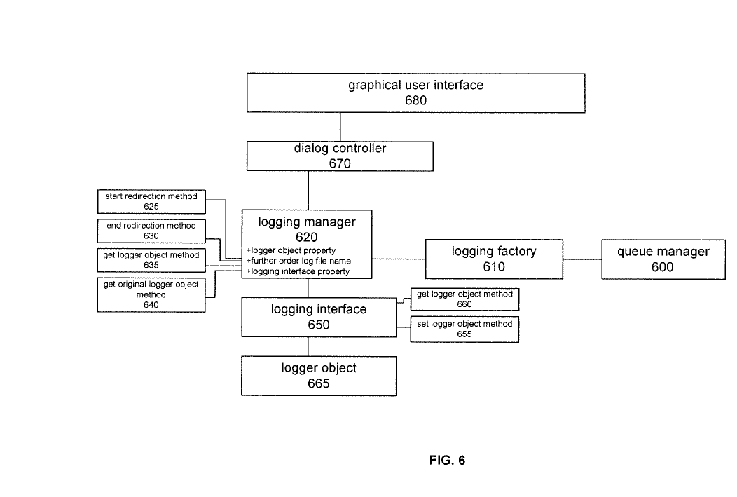

FIG. 6 is a block diagram of a system that implements an embodiment of the present invention. In one embodiment of the present invention, a queue manager 600 creates a queue of tasks to be performed as part of a maintenance procedure and triggers the procedure. The queue manager also saves a file describing the procedure to the file system so that if the maintenance procedure cannot be completed for any reason the file can be retrieved at a later point and the procedure can be resumed or restarted. The queue manager invokes a logging factory 610 to create a logging manager 620. The logging factory 610 creates the logging manager with the following properties: a name property to store the name of the further log file to be used, a logger object property pointing to the higher order (original) log file, and a logging interface property to point to a logging interface instance that supplies the current logger object. The logging interface 650 has a method to set the logger object for usage 655 and a method to get the logger object to use 660. Thus, components in the system can appoint a current logger object 665 to use and later retrieve the appointed logger object 665. A current logger object is the logger object that writes data to a log file, that is, at different stages of the procedure the logger object will point to the file currently used for logging. An example of this process is the logging manager 620 invoking a call to the start redirection method 625. The start redirection method 625 performs three tasks. It creates a further order log file with the name specified in the name property of the logging manager, records a notification message to the higher order log file that redirection starts, and creates a new instance of the logger object pointing to the newly created further order log file. From this point onwards, until a change to the logger object is made, all components requesting the logger object will obtain the current one and record messages to the file the logger object points to. The logging manager then starts logging messages to the further order log file. Once all available output for that event is recorded, the logging manager invokes the stop redirection method 630. The stop redirection method 630 closes the further order log file, restores the original logger object instance pointing to the higher order log file, and sends a notification to the higher order log file that details about a given event have been recorded to a further order log file. From this point forward, until the logger object is changed, all components requesting the logger object will obtain the original logger object pointing to the original higher order log file and will record data in the original higher order log file. After the maintenance procedure is completed, the logging manager 620 may invoke a dialog controller 670. The dialog controller 670 may in turn invoke a graphical user interface 680 to display the logical hierarchy of files created during the maintenance procedure.

Elements of embodiments may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
creating a logical hierarchy of log files in which second order log files are dependent from a first order log file:
maintaining a record for each event occurring during a maintenance procedure performed on software components in the first order log file;
redirecting detailed data about each event to a second order log file.

2. The method of claim 1, further comprising:
relating an arbitrary number of second order log files to the first order log file based at least in part on a number and complexity of events occurring during the maintenance procedure.

3. The method of claim 1, wherein creating comprises:
establishing one or more additional orders of log files each file of a subsequent order depending on exactly one log file in a next higher order.

4. The method of claim 1, wherein log files on any order are unrelated to each other and related to at most one higher order log file.

5. The method of claim 1, wherein maintaining comprises:
writing a message to a log file, the message including:
a timestamp value indicating a date and time of the event;
a severity value indicating an importance of the event;
a location in the file system of any related second order log file; and
a location in the executed source code that produced the event.

6. The method of claim 1 further comprising:
displaying the created logical hierarchy of log files is in a graphical user interface.

7. The method of claim 1, further comprising:
filtering records written in the second order log file using a severity level value;
analyzing data in the retrieved set of messages; and
correcting a cause of and event that triggered the message.

8. A machine readable medium having instructions therein that when executed by the machine cause the machine to:
apply a maintenance procedure to a software component;
identify at least one event occurring during the maintenance procedure; and
log the event to a set of hierarchical log files.

9. The machine readable medium of claim 8, wherein the instructions that cause the machine to log, cause the machine to:
obtain an instance of a logging factory;
create a logging manager using the logging factory;
call a method to start redirection of output from a first order log file to a further order log file; and
call a method to stop redirection of output from a first order log file to a further order log file.

10. The machine readable medium of claim 9, wherein instructions causing the machine to create a logging manager comprise instructions causing the machine to:
apply a logger object property to the logging manager;
apply a name property for the further order log file to the logging manager; and
apply a logging interface property to the logging manager.

11. The machine readable medium of claim 9, wherein instructions causing the machine to call a method to start redirection comprise instructions causing the machine to:
create a further order log file a with the name specified in the name property of the logging manager;
record a notification for start of redirection into the first order log file; and
create a new instance of the logger object pointing to the further order log file to record messages to the further order log file.

12. The machine readable medium of claim 9, wherein instructions causing the machine to call a method to stop redirection comprise instructions causing the machine to:
close the further order log file;
restore the instance of the logger object pointing to the first order log file; and
record a notification for recorded details in the first order log file.

13. A machine readable medium having instructions therein that when executed by the machine cause the machine to:
select an event occurring during a maintenance procedure performed on a software component to analyze from a first order log file according to a set of predefined criteria;
traverse a logical hierarchy of log files comprising messages about events related to the selected event;
estimate if the event can be handled automatically using the collected data from the logical hierarchy of log files;
construct a procedure to handle the event selected from the first order log file based on the analysis of collected data; and
apply the procedure to the software component.

14. The machine readable medium of claim 13, wherein instructions causing the machine to select an event occurring during a maintenance procedure comprise instructions causing the machine to:
retrieve a set of predefined criteria for selection from a location accessible to the medium; and
filter events recorded in the first order log file using at least one of the predefined criteria.

15. The machine readable medium of claim 13, wherein instructions causing the machine to estimate if the event can be handled automatically comprise instructions causing the machine to:
retrieve a handling policy from a location accessible to the medium; and
evaluate the event against the retrieved policy.

16. A system comprising:
a logging factory to create a logging manager;
a logging manager to invoke methods for starting and stopping redirection to a further order log file;
a logging interface coupled to the logging manager to obtain a logger object indicating the log file currently used for logging;
a method to start redirection to the further order log file; and
a method to stop redirection to the further order log file.

17. The system of claim 16, wherein the logging manager comprises:
a logger object property to store the logger object for the first order log file;
a name property to store a name for the further order log file; and
a logging interface property to store the logging interface to query for a logger object.

18. The system of claim 16, wherein the logging interface comprises:
a method to set the logger object indicating the log file currently used for logging; and
a method to get the logger object indicating the log file currently used for logging.

19. The system of claim 16, further comprising:
a queue manager to execute a maintenance procedure on a software component, the maintenance procedure including a set of tasks to perform; and
a dialog controller to invoke a graphical user interface (GUI) to display a plural level logical hierarchy of log files of messages about events occurring during the execution of the maintenance procedure.
